(19) United States
(12) Patent Application Publication
(10) Pub. No.: US 2015/0304346 A1
(43) Pub. Date: Oct. 22, 2015

(54) APPARATUS AND METHOD FOR DETECTING ANOMALY OF NETWORK

(71) Applicant: Huy Kang KIM, Seoul (KR)

(72) Inventor: Huy Kang KIM, Seoul (KR)

(73) Assignee: Korea University Research and Business Foundation, Seoul (KR)

(21) Appl. No.: 14/239,733

(22) PCT Filed: Aug. 17, 2012
(86) PCT No.: PCT/KR2012/006549

§ 371 Date: Feb. 19, 2014

(30) Foreign Application Priority Data
Aug. 19, 2011 (KR) 10-2011-0082786
Aug. 19, 2011 (KR) 10-2011-0082787

(51) Int. Cl. H04L 29/06; H04L 12/26

(52) U.S. Cl. CPC H04L 63/1408; H04L 43/04; H04L 63/1441

(57) ABSTRACT

Disclosed are an apparatus and method for detecting an anomaly of a network and a recording medium on which the method is recorded. The method for detecting an anomaly in a network measures self-similarity from at least one attribute information representing a traffic state of the network in a normal state in advance to set a critical value for the self-similarity, measures self-similarity in real time from the at least one attribute information in the network, and determines an anomaly of the network by comparing the measured real-time self-similarity value with the set critical value.

### TECHNICAL FIELD

This disclosure relates to an apparatus and method for detecting an anomaly of a network, particularly, to an apparatus and method for detecting an abnormal attack and anomaly based on self-similarity using a constant and repeated network pattern, and more particularly, to a method for detecting an abnormal attack and anomaly in real time by using a statistical process control chart under a circumstance where a network traffic or security event conforms to normal distribution and a recording medium on which the method is recorded.

### BACKGROUND ART

Intrusion detection is a technique for detecting the occurrence of an intrusion which threats the security of an information system, and an intrusion detection system (IDS) generally detects an internal or external manipulation which threats the system and notifies it to a manager. For this, the intrusion detection system should be capable of detecting all kinds of malicious uses of network traffics and computers, which was not detected by a traditional firewall. Therefore, the detection target of the intrusion detection system includes a network attack to vulnerable service, a data driven attack in applications, privilege escalation or invader logging-in, access to important files by an invader, and a host-based attack such as malware (computer viruses, Trojan horse, worm or the like).

The intrusion detection technique may be briefly classified into anomaly based intrusion detection and misuse detection. The anomaly based intrusion detection regards as an intrusion when a state of a network or system shows an abnormal behavior, different from existing statistical normal behaviors, and the misuse detection regards as an intrusion when a state of a network or system is identical to preset attack patterns. In particular, the anomaly based intrusion detection utilizes statistics-based approaches or prediction modeling and is known as being useful when detecting an unexpected attack not defined in an existing security system, for example an unknown attack or an attach evading a security device.

In order to detect such an anomaly, statistical data is utilized. Here, self-similarity may be utilized as a base theory for constructing such statistical data. The self-similarity has a concept based on a fractal theory and means a self-similar phenomenon in which an object looks identically or behaves identically, when being observed with different magnifications on dimension or different scales. In brief, the self-similarity represents a phenomenon in which a part is similar to the whole. For example, when a certain network is observed in a specific time range, if the variation pattern of traffic amount in a rescaled time looks similar to the variation pattern of traffic amount in the entire time range, it may be regarded as self-similarity.

Meanwhile, the statistical quality control has been performed as a part of various endeavors for managing quality of products obtained by production activity, and this has been approached to an attempt for applying a statistical method in every stage of the production activity in order to product marketable products in a most economic way.

In this regard, the statistical process control (SPC) means a method for managing production according to a desired state and quality by checking quality and process states by means of statistical data and an analyzing technique. In other words, the statistical process control activity includes a process quality maintenance activity and a process quality improving activity. Therefore, the statistical process control activity is a quality management activity for detecting an anomaly of a process in advance and then eliminating or preventing it.

In the statistical process control, an existing technique has been mainly endeavored to reduce distribution, but the recent trend is to cover all process managing procedures by using a statistical method, including an activity for analyzing whether process ability or various factors accompanied by the process are suitably set, by studying how to change the target setting or accomplishing method.

### DISCLOSURE

### Technical Problem

A first technical object of the present disclosure is to solve a problem in which an attack of a new pattern and an evasion attack cannot be detected by just misuse detection which detects an intrusion to a network or system based on preset patterns, solve inconvenience in which error patterns should be continuously updated by an expert group, and overcome a limit in which an attach from the interior of a network and system cannot be detected.

Further, the present disclosure is directed to solving a problem in which an attack of an unknown pattern cannot be detected in a situation where possible attacks increase due to the operation of a supervisory control and data acquisition (SCADA) system, and also solving economic difficulty caused by an expensive system for detecting an anomaly.

In addition, a second technical object of the present disclosure is to solve a problem in which existing intrusion detection techniques have a high detection error rate in the anomaly based intrusion detection, overcome a limit in which a statistical process control chart is limitedly utilized just for a simple process or quality management, and solve inconvenience in management caused by the absence of means for intuitively and visually providing information about a current security situation of a network or system.

### Technical Solution

In order to accomplish the first technical object, an embodiment of the present disclosure provides a method for detecting an anomaly in a network according to a predetermined standard by using a detection device having at least one processor in the network, the method including: measuring self-similarity from at least one attribute information representing a traffic state of the network in a normal state in advance and setting a critical value for the self-similarity; measuring self-similarity in real time from the at least one attribute information in the network; and determining an anomaly of the network by comparing the measured real-time self-similarity value with the set critical value.

In the method for detecting an anomaly in a network according to an embodiment of the network, the setting of a critical value for the self-similarity may include: measuring at least one attribute information representing a traffic state of the network at regular time intervals in the normal state; calculating a sample mean and dispersion from the measured attribute information; calculating a parameter for durability of a statistical phenomenon of the network traffic by using the calculated dispersion and the time interval; and setting a predetermined magnification of the calculated parameter as a critical value for the self-similarity.

In the method for detecting an anomaly in a network according to an embodiment of the network, the attribute information may be at least one of packet information of the network, attribute information about a security state of a system in the network, and a function value representing states of the network and the system.

In order to accomplish the technical object, an apparatus for detecting an anomaly of a network according to an embodiment of the present disclosure includes: a storage unit for storing a critical value set by measuring self-similarity from at least one attribute information representing a traffic state of the network in a normal state in advance; a measuring unit for measuring self-similarity in real time from the at least one attribute information in the network; and a determining unit for determining an anomaly of the network by comparing the measured real-time self-similarity value with the set critical value.

In the apparatus for detecting an anomaly in a network according to an embodiment of the network, at least one attribute information representing a traffic state of the network may be measured at regular time intervals in the normal state, a sample mean and dispersion may be calculated from the measured attribute information, a parameter for durability of a statistical phenomenon of the network traffic may be calculated by using the calculated dispersion and the time interval, and a predetermined magnification of the calculated parameter may be set as a critical value for the self-similarity and stored in the storage unit.

In order to accomplish the second technical object, a method for detecting an anomaly according to another embodiment of the present disclosure includes: receiving security attributes representing states of a network or system in a normal state and classifying the received security attributes according to recent occurrence time of the attributes, occurrence frequency of the attributes and total occurrence amount of the attributes; calculating a statistical process control chart according to the classified security attributes and setting a critical range for the calculated statistical process control chart; calculating a location in the statistical process control chart in real time from the security attribute of the network or system according to the classified security attributes; and determining an anomaly of the network or system by checking whether the location of the security attribute calculated in real time is within the set critical range.

In the method for detecting an anomaly in a network according to another embodiment of the network, the security attribute may occur according to normal distribution.

In the method for detecting an anomaly in a network according to another embodiment of the network, the statistical process control chart may set a mean of simples with respect to the security attribute as a center line, and set a predetermined magnification of the standard deviation of the samples as the critical range.

In the method for detecting an anomaly in a network according to another embodiment of the network, the statistical process control chart may set a predetermined magnification of the mean of simples with respect to the security attribute as the critical range so that a variation range of the security attribute is within the critical range.

In the method for detecting an anomaly in a network according to another embodiment of the network, the statistical process control chart may set a mean of failure ratios of the samples with respect to the security attribute as a center line and set a standard deviation of the failure ratio distribution as the critical range.

The method for detecting an anomaly in a network according to another embodiment of the network may further include visualizing the calculated statistical process control chart, comparing a security attribute of a network in which an anomaly is detected with the set critical range, and displaying a result on the visualized statistical process control chart.

Further, there is also provided a computer-readable recording medium, on which a program for executing the method for detecting an anomaly as described above in a computer is recorded.

### Advantageous Effects

According to the embodiments of the present disclosure, since self-similarity of a network in a normal state is measured in advance and then a self-similarity value of the network measured in real time is compared with a set critical value, it is possible to detect a new-type attack having an unknown pattern or an evasion attack, to detect an attack from an interior or exterior of a network and system without continuously updating error patterns and without any help of an expert group, to reduce a detection error rate, and to improve accuracy of the intrusion detection.

Further, any separate additional hardware is not required when applying the embodiments of the present disclosure to a SCADA system, and the present disclosure may be flexibly applied to various kinds of equipment since it is independent from systems and standards.

Meanwhile, in the embodiments of the present disclosure, since a security attribute representing a state of the network or system in a normal state is received and a statistical process control chart is calculated according to security attributes classified based on recent occurrence time, occurrence frequency and total occurrence amount and compared with a real-time statistical process control chart, it is possible to improve accuracy of the anomaly based intrusion detection. In addition, since the statistical process control chart is visualized and provided to a manager as an anomaly detection management tool, it is possible to intuitively provide information about a current security situation of the network or system to a user.

### DESCRIPTION OF DRAWINGS

FIG. 1 is a diagram for illustrating self-similarity of a network traffic, which appears in a network circumstance in which embodiments of the present disclosure are implemented.

FIG. 2 is a diagram comparatively showing a traffic graph of a general network and a traffic graph of the network in which embodiments of the present disclosure are implemented.

FIG. 3 is a flowchart for illustrating a method for detecting an anomaly of a network by using a detection device having at least one processor in the network according to an embodiment of the present disclosure.

FIG. 4 is a flowchart for illustrating a process of setting a critical value for the self-similarity in more detail in the method of FIG. 3 according to an embodiment of the present disclosure.

FIG. 5 is a diagram for illustrating a process of calculating a snapshot vector which is one of attribute information representing a state of a system, in the method for detecting an anomaly of a network according to an embodiment of the present disclosure.

FIG. 6 is a block diagram showing an apparatus for detecting an anomaly of a network according to an embodiment of the present disclosure.

FIG. 7 is a flowchart for illustrating a method for detecting an anomaly of a network according to another embodiment of the present disclosure.

FIG. 8 is a diagram showing a method for classifying and arranging security attributes representing states of a network in the anomaly detecting method of FIG. 7 according to another embodiment of the present disclosure.

FIG. 9 is a diagram for illustrating a statistical process control chart in relation to the anomaly detecting method of FIG. 7 according to another embodiment of the present disclosure.

FIG. 10 is a diagram for illustrating a method for displaying a security attribute of a network from which an anomaly is detected, on a visualized statistical process control chart in comparison to a critical range, in the anomaly detecting method of FIG. 7 according to another embodiment of the present disclosure.

### BEST MODEL

A method for detecting an anomaly in a network by using a detection device having at least one processor in the network according to an embodiment of the present disclosure includes: measuring self-similarity from at least one attribute information representing a traffic state of the network in a normal state in advance and setting a critical value for the self-similarity; measuring self-similarity in real time from the at least one attribute information in the network; and determining an anomaly of the network by comparing the measured real-time self-similarity value with the set critical value.

In addition, a method for detecting an anomaly according to another embodiment of the present disclosure includes: receiving security attributes representing states of a network or system in a normal state and classifying the received security attributes according to recent occurrence time of the attributes, occurrence frequency of the attributes and total occurrence amount of the attributes; calculating a statistical process control chart according to the classified security attributes and setting a critical range for the calculated statistical process control chart; calculating a location in the statistical process control chart in real time from the security attribute of the network or system according to the classified security attributes; and determining an anomaly of the network or system by checking whether the location of the security attribute calculated in real time is within the set critical range.

### MODE FOR INVENTION

Prior to describing embodiments of the present disclosure proposed to solve the first technical object, characteristics of a network traffic in which the embodiments of the present disclosure are implemented will be introduced, and a basic idea of the present disclosure conceivable from environmental characteristics in which the embodiments are implemented will be proposed.

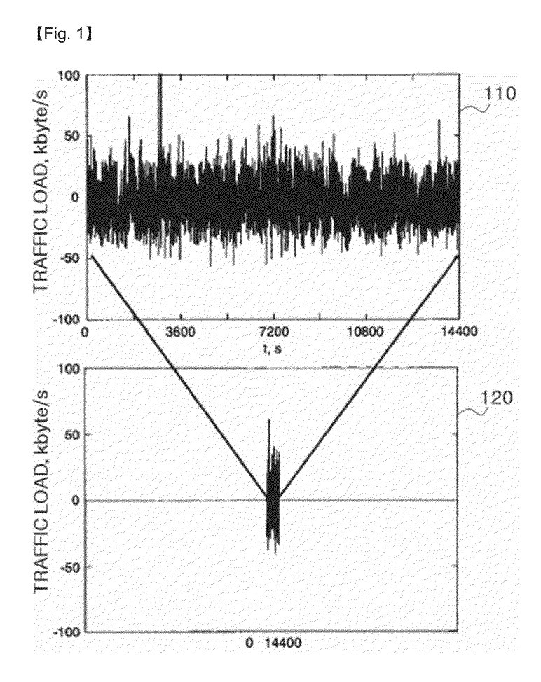

FIG. 1 is a diagram for illustrating self-similarity of a network traffic, which appears in a network circumstance in which embodiments of the present disclosure are implemented, where a horizontal axis represents time and a vertical axis represents a traffic load. In other words, FIG. 1 assumes a system or network traffic as time series data and derives self-similarity therefrom. Here, the term ‘time series’ means a certain variable with respect to an independent variable, time. For example, data observed ordered in time, for example by year, by quarter, by month, by day or by time may be regarded as time series data.

When analyzing such time series data, an interval between observation views (time lag) plays an important role. Time series is expressed like Equation 1 below by using time t as a subscript.

xₜ:t=1,2,3, . . . n [Equation 1]

Based on such time series data, auto-correlation and auto-correlation function will be described.

In time series data, a current state has a relation with past and future state. This relationship in the time series data may be expressed with an auto-correlation function. The auto-correlation shows whether a single time series has a repeated pattern in the time series according to time, namely auto-correlation.

In more detail, the auto-correlation function represents the degree of similarity of results observed from different viewpoints t₁, t₂ (which may also be expressed as t, t+τ). The auto-correlation function R may be expressed like Equation 2 below.

Rₓ(t₁,t₂)=Rₓ(t,t+τ)=E[x(t)x(t+τ)] [Equation 2]

Here, R represents an auto-correlation function, and E represents a mean.

Now, in order to quantize the auto-correlation, probabilistic representation will be introduced.

The stationary probability process is a generic term of probability processes having any kind of stationarity with respect to time alternateness and is briefly classified into a strong stationary process and a weak stationary process. With respect to a probability process {X(t)}, if joint distribution of X(t₁), X(t₂), . . . , X(tₙ) always agrees with joint distribution of X(t₁+τ), X(t₂+τ), . . . , X(tₙ+τ), this process is called a strong stationary probability process. Meanwhile, both the mean E(X(t)) of X(t) and the mean E(X(t)X(t+τ)) of X(t)X(t+τ) have no relation with t, this process is called a weak stationary probability process.

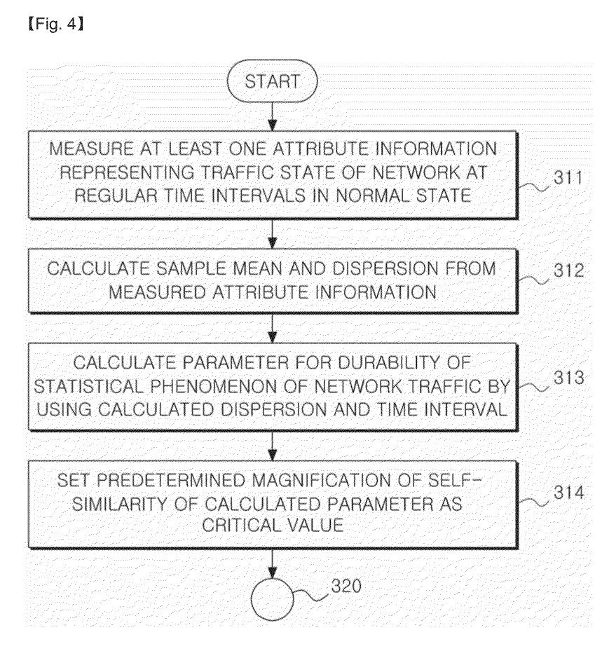

The following embodiments of the present disclosure propose a method for detecting an anomaly of a network traffic by the fact that a network traffic without an anomaly, namely without an abnormal intrusion from a system and network, is in a normal state (which means that the network traffic conforms to the stationary probability process). In a more practical point of view, a method for applying such an attribute to self-similarity will be described later with reference to FIG. 4.

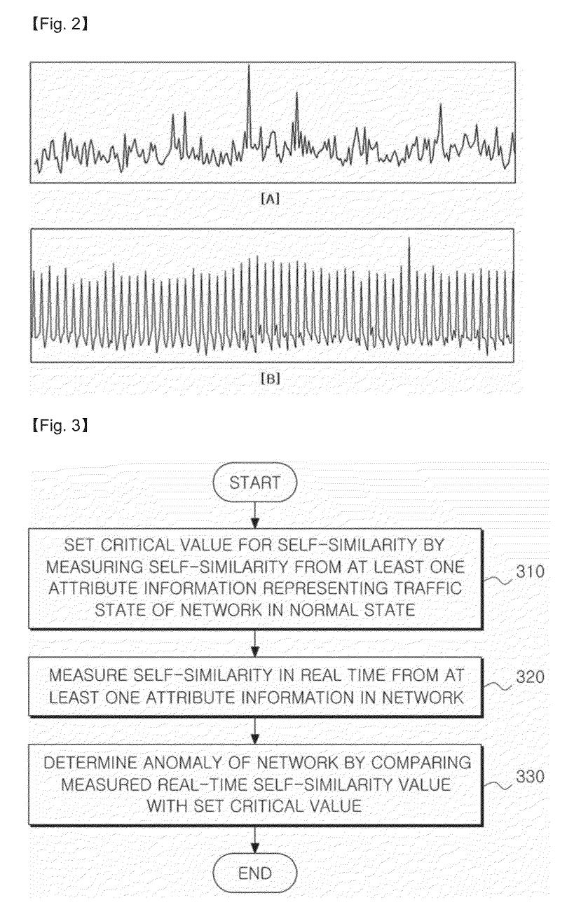

FIG. 2 is a diagram comparatively showing a traffic graph of a general network and a traffic graph of the network in which embodiments of the present disclosure are implemented.

The embodiments of the present disclosure are commonly implemented in a circumstance having a network pattern with self-similarity in a normal state, and the network traffic in such a normal state premises that a plurality of network traffics having different scales with respect to time vary with similar self-similarity. Hereinafter, as an example of this standard, the embodiments of the present disclosure will be described based on a supervisory control and data acquisition (SCADA) system.

The SCADA system allows a remote terminal unit to collect, receive, record and display state information data of a remote device and also allows a central control system to monitor and control the remote device. At present, important government-controlled core foundation facilities such as power plants, power transmission and distribution equipment, water and sewage equipments, petrochemical plants, high-speed trains, gas facilities, iron-foundry plants and factory automation equipment are mostly operated based on the SCADA system. Network traffics of such a SCADA system are constant and regular, and the self-similarity is greatly and clearly observed in comparison to general network traffics.

An intrusion detecting methodology performed by measuring self-similarity, proposed in the embodiments of the present disclosure, is advantageously applied to a special circumstance, namely the SCADA system. Since the SCADA system should operate with a break, it is difficult to install an additional security solution or device. In most cases, in order to set a security tool or update an operating system, a rebooting process for activating the corresponding solution is inevitable, which may needs to stop the foundation facility. If a security tool erroneously determines a normal state as an intrusion situation, huge social damages such as interruption of operation of a foundation facility or loss of important data may occur. For these reasons, it is practically difficult to install an agent in a system under the SCADA system circumstance for the purpose of fusibility and prevention of obstacle induction. Thus, it should be avoided to directly and actively cope with the SCADA system in operation. In addition, for agreeable operation, it should be avoided to cause a load to the system.

Portion [A] of FIG. 2 shows the number of packets according to time, observed for about 1 hour from 16:25:586 to 17:26:49 on Jun. 27, 2011 from a computer in an anti-hacking technique laboratory of the Korea University. Behaviors performed during this period include normal web surfing, messenger activities or the like. Generally, it is known that network traffics exhibit an irregular traffic pattern due to various activities of users but have self-similarity.

Portion [B] of FIG. 2 shows a traffic pattern for about 1 hour, observed at a specific SCADA system in Korea. Compared with Portion [A] of FIG. 2, it may be found that Portion [B] of FIG. 2 shows a very regular and constant traffic pattern. Since the SCADA system is a closed network having a special purpose, communication protocols and communication subjects are limited and thus network traffics have a constant pattern. Therefore, the SCADA system has greater self-similarity in comparison to general network traffics.

Standards used for SCADA communication adopt various schemes such as distributed network protocol (DNP), Modbus, Harris, TCP/IP, intercontrol center communications protocol (ICCP) or the like, different from general Internet communication, and since these standards are determined depending on a system structure, a control grade and a measurement/control subject, many standards may be used together in a single system.

A method using a pattern matching process which may be commonly utilized for intrusion detection, a method for detecting a network pattern according to a fixed network device, and a method using a separator monitoring system based on a rule have a complicated detection process or demand an additional hardware device when performing the intrusion detection of the SCADA system.

In most countries, at present, the SCADA system is operated in a closed network, and vender-inherent operating systems and protocols are used. However, in order to maximize the cost effectiveness, it is being attempted to operate in connection with a commercial network. For example, a smart grid proposes a power system utilizing a dispersion method in order to improve inefficiency of the centralized and one-direction management method of an existing electrical grid. If such a SCADA system is operated in connection to a commercial network, hacker intrusion paths increase and expand in comparison to the existing case, which results in the increase of possible attacks. In addition, if the SCADA system is attacked and damaged by a hacker, a big damage may occur against human lives and economy due to its applications and scales.

Under this circumstance, various attack paths should be expected. For this reason, an unknown attack (zero day attack) against the SCADA system should also be effectively detected, and the accuracy and reliability of the detection should also be enhanced. As described above, existing system security methods have a complicated detection process or demand an additional device. In addition, in order to detect an anomaly, a complicated process should be performed or an additional cost occurs, and a state of the system should be continuously monitored and updated for the detection.

Therefore, the following embodiments of the present disclosure provide a method for detecting an anomaly of a network traffic by measuring self-similarity, from the understanding that traffics generated at a SCADA network have a constant and repeated pattern. In other words, since statistical characteristic values of the SCADA network may be defined by the time unit, intrusion detection may be performed using the self-similarity in which statistical characteristic values repeat like a fractal structure. The intrusion detection using self-similarity does not need an additional device or modeling process, different from a general intrusion detection method described above. In addition, the intrusion detection using self-similarity may be applied to any field as long as an intrusion detection system is implemented, since the intrusion detection using self-similarity does not depend on a device.

However, the SCADA system is just an example of the circumstance in which the embodiments of the present disclosure are implemented, and the present disclosure is not limited to the SCADA system. Therefore, a person skilled in the art of the present disclosure will understand that various embodiments may be flexibly applied in a circumstance having a constant and repeated network pattern like the above SCADA system (namely, in a circumstance where self-similarity appears clearly), as long as the basic idea of the present disclosure is maintained. Hereinafter, the embodiments of the present disclosure will be described in detail with reference to the accompanying drawings. In the drawings, like reference numerals denote like elements.

FIG. 3 is a flowchart for illustrating a method for detecting an anomaly of a network by using a detection device having at least one processor in the network according to an embodiment of the present disclosure. As assumed above, the network of this embodiment has a constant and repeated network pattern with self-similarity. Therefore, the network of this embodiment has strong self-similarity in a normal state. Under this circumstance, if an intrusion occurs, the state of the network traffic varies, which changes the degree of self-similarity. In other words, in the detection method of FIG. 3, an intrusion may be detected by using this characteristic.

In Step 310, the detection device sets a critical value for self-similarity by measuring self-similarity from at least one attribute information which represents a traffic state in a normal state in advance. In this step, subject data to be observed is selected, any data is observed for a network state or at least one subject in the system, and it is determined whether or not to analyze the observed data. For example, if a network state is selected as an observation subject, information about a packet or information about a traffic will be analyzed. As another example, if a system state is selected as an observation subject, an event log loaded in an operating system (OS) may be analyzed. If a measurement/analysis subject is determined in this way, detailed attribute information of the data to be observed and analyzed is selected. If the network state is selected as a subject, a packet size, the number of packets per unit time, packet occurrence time or the like may be selected as the attribute. If the system state is selected as a subject, Event ID, Security ID (SID) or the like may be selected as the attribute among various event logs.

Now, self-similarity is measured from the selected attribute information. The self-similarity is specialized or digitized into a specific parameter for durability of a statistical phenomenon of the network traffic. In order to calculate the self-similarity, data is extracted at regular time interval with regard to the attribute and set as samples, and a mean and dispersion of the samples is calculated. The calculated self-similarity value is a value for the network traffic in a normal state and thus has relatively higher self-similarity in comparison to a general network or a network having an anomaly. Therefore, from this, a critical value for determining an anomaly is set.

In Step 320, the detection device measures self-similarity from the at least one attribute information in real time in the network. In other words, Step 320 corresponds to a process of detecting an anomaly in an actual network. At this time, the attribute information for measuring self-similarity is selected in Step 310 as a matter of course. By means of observation and analysis for the same attribute information, the self-similarity measured in real time at a current network may be compared with the self-similarity value in the normal state calculated in Step 310.

In Step 330, the detection device determines an anomaly of the network by comparing the real-time self-similarity value measured in Step 320 with the critical value set in Step 310. In this case, the real-time self-similarity value is compared with the preset critical value, and if the real-time self-similarity value is lower than the set critical value as a result of the comparison, it may be determined that the network has an anomaly. In other words, if an illegal intrusion exists at the current network, the real-time self-similarity value departs from the range of the critical value, which may be regarded as an intrusion.

In this embodiment, the detection device includes at least one processor for performing a series of operations described above. The processor calculates a mean and dispersion from the sample data extracted from various attribute information of a network or system, and calculates self-similarity from the mean and dispersion to set a critical value. In addition, the processor compares the set critical value with a current self-similarity calculated in real time, thereby determining an anomaly of the network. Further, the detection device may further include a memory used for temporarily or normally storing a calculation procedure while the processor performs a series of operations. An additional software code may also be used for performing the operations by using the processor and the memory.

FIG. 4 is a flowchart for illustrating a process of setting a critical value for the self-similarity in more detail in the method of FIG. 3 according to an embodiment of the present disclosure, in which only Step 310 is depicted. Here, only a process of calculating a parameter obtained by digitizing self-similarity will be focused, without repeating the same description. The self-similarity may be expressed as a digit by means of various technical schemes, and the following embodiments will be based on a Hurst parameter, for example. Even though the Hurst parameter is utilized for digitizing the self-similarity, a person skilled in the art of the present disclosure will understand that a technique for expressing the self-similarity is not limited to the Hurst parameter.

In Step 311, the detection device measures at least one attribute information which represents a traffic state of the network at regular time intervals in a normal state.

Next, in Step 312, the detection device calculates a sample mean and dispersion from the measured attribute information.

Subsequently, in Step 313, the detection device calculates a parameter for durability of a statistical phenomenon of the network traffic by using the dispersion calculated in Step 312 and the time interval of Step 311.

A general definition of a probability process with self-similarity is based on direct scaling of a continuous time parameter. If the probability process X(t) has a statistical feature of a ^{-H}X(at) for any real number a (>0), X(t) is regarded as a process having statistical self-similarity with a Hurst parameter H (0.5<H<1). This relation may be expressed for three conditions as in Equations 3 to below.

$$\begin{matrix}E [ x ( t ) ] = \frac{E [ x ( at ) ]}{{a}^{H}} & [ Equation 3 ] \\ Var [ x ( t ) ] = \frac{Var [ x ( at ) ]}{{a}^{2 H}} & [ Equation 4 ] \\ {R}_{x} ( t , s ) = \frac{{R}_{x} ( at , as )}{{a}^{2 H}} & [ Equation 5 ]\end{matrix}$$

Equation 3 above represents a mean, Equation 4 represents dispersion, and Equation 5 represents an auto-correlation. Here, the Hurst parameter H is a main measure for self-similarity. In other words, H is a measure for durability of a statistical phenomenon. If H is 0.5, this means there is no self-similarity. If H is close to 1, this means that the degree of durability or long-term dependence is great and the degree of self-similarity is great.

In order to define more practical and inclusive self-similarity, it may be conceived to measure a Hurst parameter for a weak stationary probability process having a mean μ, dispersion σ², and an auto-correlation function r(k)˜k^{-β}L(k). With respect to each m=1, 2, . . . , a stationary probability process X(^{m}) like Equation 6 below is defined. [Equation 6]

$${X}_{k}^{( m )} = \frac{1}{m} ( {X}_{( k - 1 ) m} + … + {X}_{km - 1} ) , \\ k \geq 1 \qquad [ Equation 6 ]$$

The newly defined X(^{m}) corresponds to a probability process obtained by averaging original time sequence X with a non-overlapping block size m.

If the stationary probability process X meets the conditions of Equation 7 and Equation 8 below, this is regarded as a probability process with secondary self-similarity having a Hurst parameter

$$H = 1 - \frac{β}{2}$$

in a strict meaning or in an asymptotic meaning. Equations 7 and 8 respectively show conditions in a strict meaning or in an asymptotic meaning.

r^{(m)}(k)=r(k)=½((k+1)^{2H}−2k^{2H}+|k−1|^{2H}), k≧0 [Equation 7]

r^{(m)}(k)→r(k), as m→∞, t=1,2,3, . . . [Equation 8]

Now, based on this understanding, a process of calculating a Hurst parameter will be described. Dispersion of a sample mean of the probability process is expressed in Equation 9 below.

Var (̅X̅ₘ̅)̅→cm^{2H-2}, ∇c>0 [Equation 9]

If log values are put into both terms of Equation 9, it is arranged like Equation 10 below.

log S²(k)=log c+(2H−2)log k+εₖ, where εₖ˜N(0,σ²) [Equation 10]

The Hurst parameter H may be calculated from regression analysis slopes of log S²(k) and log k like Equation 11 below.

H=1+½(regression slope) [Equation 11]

At this time, log S²(k) represents Var (̅X̅ₘ̅)̅, namely a log value of the dispersion of the sample mean. In addition, log (k) represents a log value of the time interval. In other words, the Hurst parameter conforms a slope value of the regression line obtained by performing the regression analysis to a log value of the dispersion and a log value of the time interval.

In brief, the self-similarity is measured by extracting samples in which data is integrated at regular time intervals, calculating a log value of the time interval and a log value of the dispersion of the sample mean, and calculating a Hurst parameter through a slope value of a regression line derived by performing the regression analysis between log values of sample dispersion according to various time intervals.

Finally, in Step 314, the detection device sets a certain magnification of the parameter, calculated in Step 313, as a critical value for the self-similarity.

The magnification of self-similarity for the measured normal state may be suitably determined through experiments.

Meanwhile, the attribute information observed as a detection subject during the above detecting process may be at least one selected from packet information of the network, attribute information about a security state of a system in the network, and a function value representing a state of the network and system. The attribute information may be obtained from at least one of a packet in the network and an event log of the system in the network. Representative three attributes will be described in more detail.

First, the state information about the network traffic may be obtained from various measurement value about the packet.

Second, the state information about the system may be particularly focused on state information about security of the system. For example, assuming that the Windows® system of Microsoft® is a detection subject system, Security ID (SID) may be utilized as attribute information the system state. SID is an inherent number endowed to each user or work group in a Windows NT server. An internal security card made by log-on of a user is called an access token, which contains security IDs of a logging-on user and all work groups to which the user belongs. Copies of the access token are allocated to all processes initiated by the user.

In addition, a Windows server may also utilize an Event ID as the attribute information representing a state of the system. Among various Event IDs recorded in the event log, an event relating to security may have a special meaning about anomaly detection. Table 1 below exemplarily shows Event IDs defined in a Windows server and their explanations. In Table 1, Event IDs relating to security are 529 and 539.

TABLE 1

| Event ID | Occurrence | Description |
|---|---|---|
| 529 | Logon Failure - | It indicates an attempt to login |
| | Unknown User | with wrong account name or password. |
| | Name or Password | When this event repeats a lot, then |
| | | that can be password-guessing attack |
| | | by brute-force. |
| 539 | Account Locked | It indicates an attempt to log on |
| | Out | with an account that has been |
| | | locked out. |
| 627 | Change Password | It indicates that someone other than |
| | Attempt | the account holder attempted to |
| | | change a password |

In brief, the attribute information about a security state of the system to detect an anomaly preferably includes at least one of inherent identifier (security ID, SID) information endowed to a user or work group accessing the system and security event information (Event ID) of the system.

Third, a function representing a state of the system or network may also be utilized as attribute information for detecting an anomaly. For example, a function (g) representing an occurrence number of the SID or Event ID or a specific vector representing a state of the system and network may be utilized. The function (g) and the vector may be expressed like Equation 12 and Equation 13 below.

g_{xy}=g(SIDₓ,EventID_{y}) [Equation 12]

The function of Equation 12 expresses a single function value in which SID and Event ID are grouped. For example, this may be utilized to express ‘login failure number’ of ‘manager A’ in a single group.

$$\vec{{G}_{t}} = ( \begin{matrix}{g}_{11} , {g}_{12} , {g}_{13} , … , {g}_{1 n} , \\ {g}_{21} , {g}_{22} , {g}_{23} , … , {g}_{2 n} , \\ … \\ {g}_{m 1} , {g}_{m 2} , {g}_{m 3} , … , {g}_{mn} ,\end{matrix} ) \\ where \\ x = 1 , 2 , … , m \\ and \\ y = 1 , 2 , … , n \qquad [ Equation 13 ]$$

The vector of Equation 13 expresses function values of Equation 12 as a single group in which various object identifiers and event patterns are grouped, which corresponds to a snapshot vector about a state of the system and network since all attributes of the system at a specific time point may be displayed in a bundle.

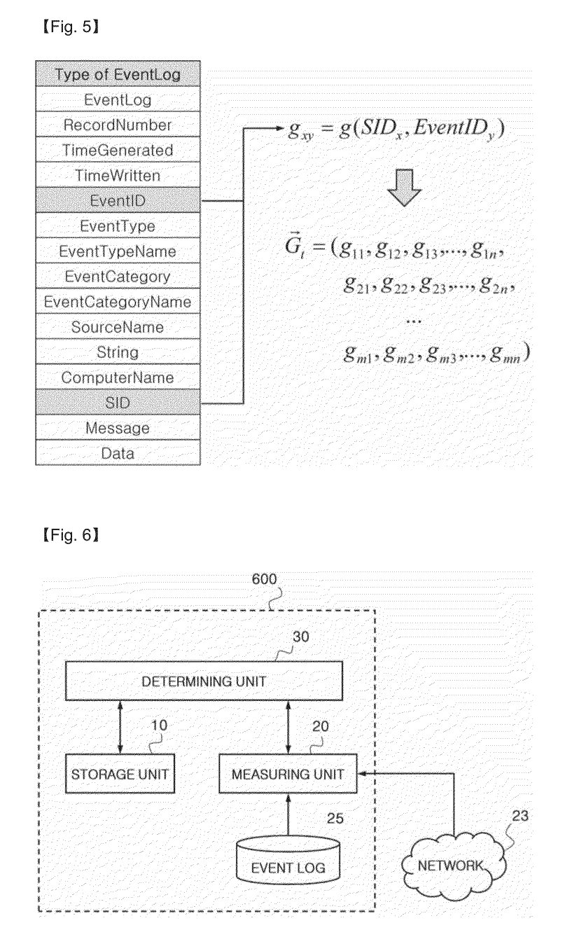

FIG. 5 is a diagram for illustrating a process of calculating a snapshot vector which is one of attribute information representing a state of a system, in the method for detecting an anomaly of a network according to an embodiment of the present disclosure. Referring to FIG. 5, various patterns of an event log recorded in the system are exemplified, and in this embodiment, Event ID and SID relating to security are selected. The selected attribute information is expressed as a function (g) representing occurrence numbers of SID and Event ID, and it may be found that a snapshot vector collectively expressing an entire state of the system may be derived therefrom.

In brief, the function value representing a state of the system preferably includes at least one of a function value representing occurrence numbers of inherent identifier information endowed to a user or work group accessing the system and security event information of the and a snapshot vector obtained by grouping all subjects of a function value representing an occurrence number of security event Information of the system.

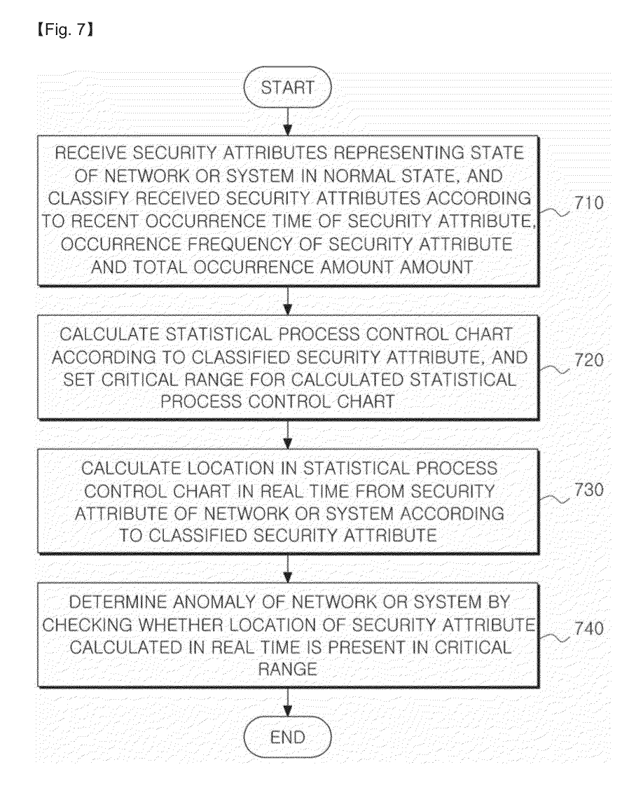

FIG. 6 is a block diagram showing an anomaly detecting apparatus 600 of a network according to an embodiment of the present disclosure, which includes a storage unit 10, a measuring unit 20 and a determining unit 30. In addition, an event log 25 recording a state of a network 23 and a state in the system, which are detection subjects of the detecting apparatus 600, is additionally depicted. At this time, the network of this embodiment is also assumed as having a constant and repeated network pattern with self-similarity. Each component depicted in FIG. 6 corresponds to each step of the detecting method described above with reference to FIG. 3 and therefore is not described in detail here.

The storage unit 10 stores a critical value set by measuring self-similarity from at least one attribute information representing a traffic state of a network in a normal state in advance. At least one attribute information representing a traffic state of a network is measured at regular time intervals in a normal state, a sample mean and dispersion is calculated from the measured attribute information, a parameter for durability of a statistical phenomenon of the network traffic is calculated by using the calculated dispersion and the time interval, and a certain magnification of the calculated parameter is set as a critical value for the self-similarity and stored in the storage unit 10. Therefore, the storage unit 10 may be implemented with various recording media capable of storing a critical value set in an electronic data format.

The measuring unit 20 measures self-similarity in real time from at least one attribute information in the network 23. The attribute information may be obtained by extracting various attribute values known from the network packet or inquiring data already recorded in the event log 25 by using software, and the attribute extracting method may be implemented using various technical schemes commonly used in the art of the present disclosure by those having ordinary skill.

The determining unit 30 determines an anomaly of the network 23 by comparing the real-time self-similarity value measured by the measuring unit 20 with the critical value stored in the storage unit 10.

According to various embodiments of the present disclosure, since the self-similarity value of a network measured in real time is compared with the critical value set by measuring self-similarity of the network in a normal state in advance, it is possible to detect a new-type attack having an unknown pattern or an evasion attack, to detect an attack from an interior or exterior of a network and system without continuously updating error patterns and without any help of an expert group, to reduce a detection error rate, and to improve accuracy of the intrusion detection. Further, any separate additional hardware is not required when applying the embodiments of the present disclosure to a SCADA system, and the present disclosure may be flexibly applied to various kinds of equipment since it is independent from systems and standards.

In particular, the embodiments of the present disclosure proposes an intrusion detecting methodology based on self-similarity by conceiving a SCADA system has a constant an regular network traffic pattern. This is designed by using the phenomenon that self-similarity is apparently destroyed when an intrusion occurs in a SCADA network having a regular pattern. Therefore, the intrusion detecting methodology based on self-similarity proposed by the embodiments of the present disclosure may be suitably utilized for the SCADA system. Existing security systems have a limit in intrusion detection since their protocol systems and features are not reflected. A security technique using direct correspondence is not suitable for a SCADA system circumstance which does not allow interruption of operation. Due to such reasons, the intrusion detection of the embodiments does not need setting an additional device or modeling and checks the variation of self-similarity of the entire system by monitoring traffic at a network terminal. Therefore, there is no risk element such as interruption of operation of the system or induction of a load. In addition, since an anomaly is detected based on a statistically normal behavior by means of self-similarity measurement, it is possible to detect an unknown attack or a high-level hacking technique evading a security tool.

Heretofore, embodiments for solving the first technical object have been described. Now, prior to describing embodiments of the present disclosure proposed to solve the second technical object, a technical field in which embodiments of the present disclosure are implemented, namely a intrusion detection technique, will be generally introduced, and a basic idea of the present disclosure conceivable from environmental characteristics in which the embodiments are implemented will be proposed.

Intrusion detection is a technique for detecting the occurrence of an intrusion which threats the security of an information system, and an intrusion detection system (IDS) generally detects an internal or external manipulation which threats the system and notifies it to a manager. For this, the intrusion detection system should be capable of detecting all kinds of malicious uses of network traffics and computers, which was not detected by a traditional firewall. Therefore, the detection target of the intrusion detection system includes a network attack to vulnerable service, a data driven attack in applications, privilege escalation or invader logging-in, access to important files by an invader, and a host-based attack such as malware (computer viruses, Trojan horse, worm or the like).

The intrusion detection technique may be briefly classified into anomaly based intrusion detection and misuse detection. The anomaly based intrusion detection regards as an intrusion when a state of a network or system shows an abnormal behavior, different from existing statistical normal behaviors, and the misuse detection regards as an intrusion when a state of a network or system is identical to preset attack patterns. In particular, the anomaly based intrusion detection utilizes statistics-based approaches or prediction modeling and is known as being useful when detecting an unexpected attack not defined in an existing security system, for example an unknown attack or an attach evading a security device.

In this regard, materials and technical means utilizable for detecting an anomaly include statistics, expert systems, neural networks, computer immunology, data mining, hidden Markov models (HMM) or the like. Among them, in particular, the statistics-based detection methodology is most frequently applied in an intrusion detection system and estimates the possibility of intrusion by using statistical characteristics and relevant formulas. In other words, statistical values (which may be a mean, dispersion, standard deviation or the like) of various state variables relating to security are calculated and utilized as a basis for determining an intrusion.

However, the anomaly based intrusion detection may have a high detection error rate due to its attribute, and in order to lower the detection error rate (false-positive), the embodiments of the present disclosure proposes a new detecting method by introducing RFM (recency, frequency, monetary value) analysis and statistical process control. Each individual technical element will be described later in detail with reference to FIGS. 7 to 9.

Meanwhile, there are various schemes capable of effectively reporting the collected and analyzed data to a user or manager. Among them, a visualized reporting technique allows more rapid and accurate determination by processing data into an intuitive image and providing it to a user. In relation to security of a network or system, existing security control techniques focus on providing a large amount of information about a current network situation, and understanding and determination for such reported data entirely depends on a user. For this reason, without considerable security expertise, it is not easy for a user to accurately understand a current situation of the network or system or predict a future security state. As a result, a user who is not a high-level expert may not effectively utilize the security control system, and an expert in the art also consumes a lot of time to analyze and predict security-related information. Therefore, there is needed an effective security control service for monitoring, analyzing and coping with a network or system in real time in relation to various intrusion detections, and there is also requested a visualizing tool for helping rapid and accurate determination.

The following embodiments of the present disclosure effectively fuse an intrusion detection technique, a RFM analysis technique, and a statistical process control technique, and additionally include a visualized reporting technique capable of suggesting a result in an easy and intuitive way. In other words, the embodiments of the present disclosure detect an anomaly based on a statistical method and then report a visualized detection result. In particular, by combining the RFM analysis technique and the statistical process control technique, a detection error rate at an anomaly detecting technique may be greatly lowered, which also allows highly reliable analysis. In addition, by using the visualizing technique based on a statistical process control chart, it is possible to provide an anomaly detection situation and its result to a user, without limiting to acknowledging a simple security situation, and also to help a user lacking the expertise to easily understand a current state of the network or system.

Hereinafter, the embodiments of the present disclosure will be described in detail with reference to the accompanying drawings.

FIG. 7 is a flowchart for illustrating a method for detecting an anomaly of a network according to another embodiment of the present disclosure, by a detection device having at least one process, and the method includes the following steps.

In Step 710, the detection device receives security attributes representing a state of a network or system in a normal state, and classifies the received security attributes according to recent occurrence time of the security attribute, occurrence frequency of the security attribute and total occurrence amount of the security attribute. Step 710 is a step for collecting subject data to be observed by the detection device, and the subject data may include packet information or system log information of the network.

The following embodiments exemplifies an event in which the security attribute used as an input value in Step 710 shows a security state of the network, but a person skilled in the art of the present disclosure will understand that in various embodiments of the present disclosure, the input value is not limited to a security event of a network but may be any one of various system attributes. For example, the security attribute may be figured out by using an event log of the system and selected suitably from each system in various operating systems (OS). For example, in the Windows OS, an application log, a system log, a security log or the like will be utilizable security attributes, and in the UNIX system, wtmpx, utmpx, last log, history log, syslog, messages, secure log, authlog, pacct, ftp/http log or the like will be utilizable security attributes. Further, information such as user behavior information may also be utilized as a security attribute for detecting an anomaly of a system, user, database or network.

When classifying data, in this embodiment, features are extracted from security attributes by utilizing the RFM analysis technique, and information required for analysis is collected from the extracted features. Generally, RFM is a technique for evaluating a customer behavior and value according to three measurement criteria, namely recent occurrence time (recency), occurrence frequency and monetary value and is utilized in marketing or customer relationship management (CRM). However, in this embodiment, beyond such common utilization, the RFM analysis technique is applied by a customer behavior into a security-related event. Therefore, each classification/measurement criterion of the RFM analysis becomes recent occurrence time of the security attribute, occurrence frequency of the security attribute and total occurrence amount of the security attribute.

The classified security attributes will be utilized in Step 720 to calculate a statistical process control chart, and the security attribute occurs according to normal distribution. In other words, in the following embodiments of the present disclosure, the statistical process control chart is assumed as being applied to data conforming to normal distribution. In other words, the network traffic or security event conforms to normal distribution (the central limit theorem).

In Step 720, the detection device calculates a statistical process control chart according to the security attribute classified in Step 710, and sets a critical range for the calculated statistical process control chart. As described above, the statistical process control is a statistic technique for finding and managing a process pattern which may occur due to various factors to quality movement in the quality control (QC) field. However, in this embodiment, the network traffic is substituted into a single management process and utilized as a management tool for detecting an anomaly which may occur due to factors of quality movement (which means security attributes of various security events).

For this, the detection device calculates a statistical process control chart from the security attributes collected and classified according to the RFM analysis technique, and sets a range which may be regarded as a normal behavior in the calculated process control chart as a critical range. The critical range may be experimentally set based on various security attributes of the network traffic measured in a normal state, and may be suitably modified according to the level of security or the demand of a user.

Therefore, if a statistical process control chart is calculated and a critical range therefor is set, a suitable management level (which means the presence or absence of an anomaly) may be figured out by checking a location of a newly calculated security attribute of the network or system in the calculated process control chart. Through Steps 710 and 720, in the embodiment of the present disclosure, traffics or security events of the network in a normal state are collected and classified, and then a statistical process control chart and a critical range are calculated therefrom. As assumed above, the network traffic and the security event conform to normal distribution, and so the statistical process control chart is applied to data conforming to normal distribution. Therefore, if there is no special intrusion into the network, a newly measured security attribute will be present in the range conforming to the normal distribution. In other words, it will not be out of the critical range.

In Step 730, based on this principle, the detection device calculates a location in the statistical process control chart in real time from the security attribute of the network or system according to the security attribute classified in Step 710.

In Step 740, the detection device determines an anomaly of the network or system by checking whether the location of the security attribute calculated in real time in Step 730 is present within the critical range set in Step 720.

In other words, in Steps 730 and 740, a normal behavior learned in the past and a currently measured security attribute are compared and analyzed through the calculated statistical process control chart and used as a basis for determining an anomaly. Now, if it is determined that there is an anomaly, this is reported to the user.

In this embodiment, the detection device includes at least one processor for performing a series of operations described above. The processor classifies various security attributes of the network or system according to a specific criterion, and calculates and sets a statistical process control chart and a critical range. In addition, the processor calculates a location in the statistical process control chart from the security attribute of the network in real time and compares and checks the location with the critical range to determine an anomaly of the network. Further, the detection device may further include a memory used for temporarily or normally storing a calculation procedure while the processor performs a series of operations. An additional software code may also be used for performing the operations by using the processor and the memory.

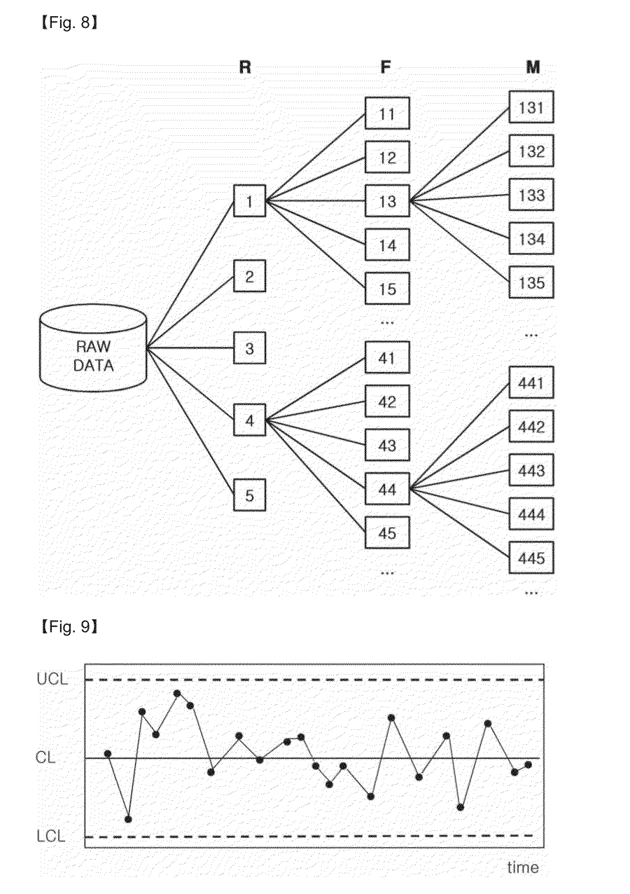

FIG. 8 is a diagram showing a method for classifying and arranging security attributes representing states of a network in the anomaly detecting method of FIG. 7 according to another embodiment of the present disclosure. As described above, the RFM analysis technique means a method for diagnosing a user pattern by using three factors, namely R (Recency), F (Frequency), M (Monetary). When the RFM analysis technique is applied to the present disclosure, R (Recency) means when a security-related event has occurred most recently, F (Frequency) means period/frequency of security-related events, and M (Monetary) means a total occurrence amount of a security-related event, which is a quantitative value such as a login time interval (duration) value or a CPU mean utilization value according to the login trial.

The security attribute may be at least one selected from packet information of the network and attribute information of the security state of a system in the network. Therefore, the security attribute may be obtained from at least one of a packet in the network or an event log of the system in the network. Now, the collected security attributes are classified according to a criterion, and arranged if required. At this time, three criteria, namely R (Recency), F (Frequency) and M (Monetary), may be used as independent variables, or associated in a subordinate relation according to a necessary order. FIG. 8 introduces an example of a method for connecting the three criteria according to a series of orders and utilizing the same, but other embodiments of the present disclosure are not limited to the example of FIG. 8, and a method for independently utilizing classification criteria and a method of arranging these criteria may be flexibly modified according to the situation.

First, in relation to the recent occurrence time of the security attribute, the detection device of this embodiment may arrange subject data in a descending order based on recent data and time, and classify the arranged data into a plurality of groups with the same size. For example, if the subject data are classified into five groups, 20% of the data will be included in each group. A result value of each individual group is calculated for the classified data. At this time, the result value means meaningful data in relation to security which is to be figured out from the individual data. For example, a login failure number or the degree of query load according to the access to a network may be used as the result value. This result value may be suitably selected or varied according to a security-related issue to be figured out.

Second, in relation to the occurrence frequency of the security attribute, the detection device of this embodiment may arrange the subject data in a descending order based on the mean occurrence frequency of each period. The following procedure is identical to a series of processes in relation to the recent occurrence time of the security attribute as described above.

Third, in relation to the total occurrence amount of the security attribute, the detection device of this embodiment may arrange the subject data in a descending order based on a mean of the total occurrence amount of each period. The following procedure is identical to a series of processes in relation to the recent occurrence time of the security attribute as described above.

Through the above process, R, F, M values classified for the security attribute may be derived, and a specific group code may be endowed to the classified group as necessary for easier electronic treatment. FIG. 8 exemplarily shows a result classified into five groups according to the above criteria, the classified R, F, M groups being subsequently connected and arranged again. Therefore, the number of classified groups is 125 (=5*5*5) in total, and for convenience, each group is endowed with a group code. In this embodiment, each group may be utilized as a subject of analysis, but if required, the groups may be connected and arranged so as to be utilized according to the purpose of the analysis. The order of R, F, M, which is a criterion of arrangement, may also change, and different weights may also be endowed to these groups. In other words, through the RFM analysis technique, the security attributes of this embodiment are classified according to detailed group characteristics, and an attribute of an individual group may be checked through a result value of the corresponding group.

FIG. 9 is a diagram for illustrating a statistical process control chart in relation to the anomaly detecting method of FIG. 7 according to another embodiment of the present disclosure. As shown in FIG. 9, the statistical process control chart includes a horizontal axis representing time and a vertical axis vertically expanding based on the center line (CL). At this time, an upper control limit (UCL) allowed in the corresponding process is set at a point spaced apart from the center by a predetermined distance in the positive (+) direction of the vertical axis, and a lower control limit (LCL) is similarly set in the negative (−) direction of the vertical axis from the center. The upper control limit and the lower control limit mean tolerance limits within which quality movement is allowed according to the variation of an attribute produced by the process, and the critical range is determined by both limits. In other words, as shown in FIG. 9, points occurring according to the time flow represent that the corresponding process is within an allowable range and quality of the current process is suitably managed. If an anomaly occurs in the statistical process control chart, a point representing quality appears out of the critical range, and distribution becomes weaker due to such factors.

If a network traffic is regarded as a single management process in other embodiments of the present disclosure by using this principle, a security attribute of the network or system is observed, a statistical process control chart is calculated therefrom, and a suitable critical range is set. As assumed above, the statistical process control chart is applied to data conforming to normal distribution. Since a network traffic or security event in the embodiments of the present disclosure is assumed as conforming to the normal distribution, if the measured security attribute is detected as being beyond the upper and lower control limit, it may be determined that an anomaly is present in the current network or system.

In aspect of utilization and implementation of the statistical process control chart, the embodiments of the present disclosure may utilize various kinds of control charts, such as a X-bar chart, a R-chart, a P-chart or the like. A person skilled in the art of the present disclosure may effectively detect an anomaly by selecting a suitable control chart according to characteristics of data to be analyzed by the detection device. Hereinafter, various kinds of control charts will be introduced in brief.

First, X̅ chart (X-bar chart) may be utilized. X̅ chart is used for managing a process in which data is expressed as continuous data, like length, weight, time, strength component, productivity or the like, and a mean control chart of data conforming to normal distribution. In particular, if X̅ chart is used, quality characteristics x are distributed similar to normal distribution according to a central limit theorem even though x̅ has a distribution other than the normal distribution, and so the property of the normal distribution may be used intactly. The upper control limit and the lower control limit of X̅ chart are defined like Equation 14 below.

UCL _{X̅}= X̅+A· R̅

LCL _{X̅}= X̅−A· R̅ [Equation 14]

In Equation 14, X̅ represents a center line of the control chart, namely a mean of previous samples or a target value, and A represents 3σ (σ: standard deviation) of the samples.

In brief, in this embodiment, the statistical process control chart may manage an anomaly of a security state of the network or system by setting a mean of samples with regard to the security attribute as a center line, and setting a predetermined magnification of the standard deviation of the samples (for example, three times of the standard deviation of the samples above and below the center line) as a critical range.

Second, the R-chart may be utilized. The R-chart may be used for managing fluctuation of a pattern data region. Here, an observation range of a specific pattern is a difference between a greatest observation value and a smallest observation value in the samples. The upper control limit and the lower control limit of the R-chart are defined as in Equation 15 below.

UCL_{R}=D· R̅

LCL_{R}=D′· R̅ [Equation 15]

In Equation 15, R̅ represents a mean of values observed in the past, and D, D′ represent 3σ (σ: standard deviation) which is a constant for determining a control limit.

In brief, in this embodiment, the statistical process control chart may manage an anomaly of a security state of the network or system by setting a predetermined magnification (for example, three times of the standard deviation 2o of the samples above and below the center line) of a mean of the samples with respect to the security attribute as a critical range so that the variation range of the security attribute is within the critical range.

Third, the P-chart may be utilized. The P-chart is used when managing a process by a defective rate and is a detective rate control chart according to binominal distribution. Even though products have several quality characteristics represented by a discriminating value, namely quality characteristics serving as management items when using a defective rate, they may be classified into defective products and acceptable products and simultaneously managed only with the P-chart. In other words, in this embodiment, the P-chart means whether a pattern of a user or network in relation to security is normal or not. In this case, a failure proportion of samples calculated by checking the number of failures or successes of security-related behaviors (for example, login trial) may be used as a random variable. The upper control limit and the lower control limit of the P-chart may be defined as in Equation 16 below.

$${UCL}_{p} = \overline{p} + z {σ}_{p} \\ {LCL}_{p} = \overline{p} - z {σ}_{p} \\ {σ}_{p} = \sqrt{\frac{\overline{p} ( 1 - \overline{p} )}{n}} \qquad [ Equation 16 ]$$

In Equation 16, σp represents a standard deviation of the failure ratio distribution, n represents a size of the samples, p̅ represents a center line of the control chart, which is a mean failure ratio in the past or a target value.

In brief, in this embodiment, the statistical process control chart may manage an anomaly of the security state of the network or system by setting a mean of failure ratios of the samples with respect to the security attribute as a center line, and setting a standard deviation of the failure ratio distribution as a critical range.

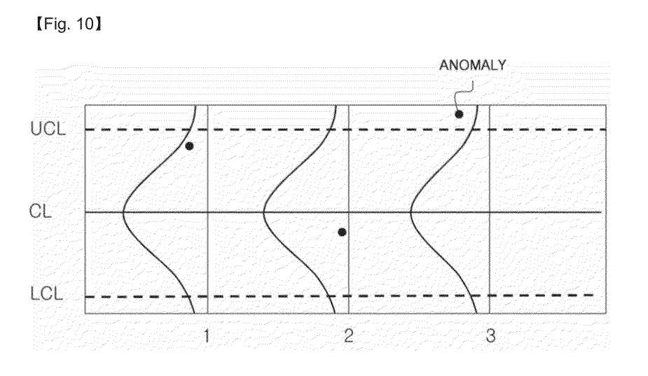

FIG. 10 is a diagram for illustrating a method for displaying a security attribute of a network from which an anomaly is detected, on a visualized statistical process control chart in comparison to a critical range, in the anomaly detecting method of FIG. 7 according to another embodiment of the present disclosure.

The security visualizing technique to be accomplished by this embodiment visualizes an enormous amount of events occurring in a network or system in real time so that a manager may intuitive recognize a security situation such as detecting an attack, classifying a type of an unknown attack, finding an anomaly or the like. For this, the visualizing technique adopted in the detecting method provides a technical scheme which may notify not only a situation (which may be an intrusion or attack) occurring in a current network, for example data selecting and collecting, characteristic factor extraction, correlation analysis, data mining, pattern analysis, event visualization or the like, but also a security situation of currently detected information by visualizing the security event. Therefore, the detection device of this embodiment visualizes the calculated statistical process control chart, compares a security attribute of a network in which an anomaly is detected with the preset critical range, and displays the result on the visualized statistical process control chart.

Referring to FIG. 10, it may be found that the upper control limit (UCL) and the lower control limit (LCL) are set based on the center line (CL), and a statistical process control chart calculated according to three criteria (1, 2, 3) is depicted. These statistical process control charts respectively conform to normal distribution, and a result value of the currently detected security attribute is displayed on the statistical process control chart. At this time, FIG. 10 displays that an anomaly is detected since the result value is out of the critical range (more accurately, the upper control limit in FIG. 10). In other words, in this embodiment, the detection device determines an anomaly by comparing a currently detected security attribute of the network with the preset critical range, and displays the result on the visualized statistical process control chart.

According to other embodiments of the present disclosure, since a security attribute representing a state of the network in a normal state is received and a statistical process control chart is calculated according to a security attribute classified based on a specific criterion and compared with a real-time statistical process control chart, the accuracy of the anomaly based intrusion detection is improved. In addition, since the statistical process control chart is utilized as a management unit for anomaly detection so that real-time statistical process control chart is visualized and provided to a manager, it is possible to intuitively provide information about a security situation of the current network or system to a user. Further, the embodiments of the present disclosure may also play a role of giving an idea so that an intrusion may be detected and studied in a new aspect by means of visualized data analysis.

Meanwhile, the embodiments of the present disclosure may be implemented as computer-readable codes on a computer-readable recording medium. The computer-readable recording medium includes all kinds of recording devices in which data readable by a computer system may be recorded.

The computer-readable recording medium may be ROM, RAM, CD-ROM, magnetic tapes, floppy disks, optical data storage or the like, or be implemented in a carrier wave form (for example, transmission through the Internet). In addition, the computer-readable recording medium may be dispersed in computer systems connected by a network, and computer-readable codes may be stored and executed in a dispersion manner. In addition, functional programs, codes and code segments for implementing the present disclosure may be easily inferred by programmers skilled in the art.

While the exemplary embodiments have been shown and described, it will be understood by those skilled in the art that various changes in form and details may be made thereto without departing from the spirit and scope of this disclosure as defined by the appended claims. In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

### INDUSTRIAL APPLICABILITY

According to the embodiments of the present disclosure, since self-similarity of a network in a normal state is measured in advance and then a self-similarity value of the network measured in real time is compared with a set critical value, it is possible to detect a new-type attack having an unknown pattern or an evasion attack, to detect an attack from an interior or exterior of a network and system without continuously updating error patterns and without any help of an expert group, to reduce a detection error rate, and to improve accuracy of the intrusion detection.

In addition, in the embodiments of the present disclosure, since a security attribute representing a state of the network or system in a normal state is received and a statistical process control chart is calculated according to security attributes classified based on recent occurrence time, occurrence frequency and total occurrence amount and compared with a real-time statistical process control chart, it is possible to improve accuracy of the anomaly based intrusion detection. In addition, since the statistical process control chart is visualized and provided to a manager as an anomaly detection management tool, it is possible to intuitively provide information about a current security situation of the network or system to a user.

1. A method for detecting an anomaly in a network according to a predetermined standard by using a detection device having at least one processor in the network, the method comprising:
measuring self-similarity from at least one attribute information representing a traffic state of the network in a normal state in advance and setting a critical value for the self-similarity;
measuring self-similarity in real time from the at least one attribute information in the network; and
determining an anomaly of the network by comparing the measured real-time self-similarity value with the set critical value.

2. The method according to claim 1, wherein said setting of a critical value for the self-similarity includes:
measuring at least one attribute information representing a traffic state of the network at regular time intervals in the normal state;
calculating a sample mean and dispersion from the measured attribute information;
calculating a parameter for durability of a statistical phenomenon of the network traffic by using the calculated dispersion and the time interval; and
setting a predetermined magnification of the calculated parameter as a critical value for the self-similarity.

3. The method according to claim 2,
wherein the parameter is a Hurst parameter, and
wherein the Hurst parameter conforms to a log value of the calculated dispersion and a slope value of a regression line by a regression analysis of a log value of the time interval.

4. The method according to claim 1,
wherein the attribute information is at least one of packet information of the network, attribute information about a security state of a system in the network, and a function value representing states of the network and the system.

5. The method according to claim 4, wherein the attribute information for a security state of the system includes at least one of:
inherent identifier (security ID, SID) information endowed to a user or a work group which accesses the system; and
security event information (Event ID) of the system.

6. The method according to claim 4, wherein the function value representing a state of the system includes at least one of:
a function value representing an occurrence number of inherent identifier information endowed to a user or a work group which accesses the system and an occurrence number of security event information of the system; and
a snapshot vector in which all objects of a function value representing the occurrence number are grouped.

7. The method according to claim 1,
wherein the attribute information is obtained from at least one of a packet in network and an event log of a system in the network.

8. The method according to claim 1, wherein said determining of an anomaly of the network includes:
comparing the measured real-time self-similarity value with the set critical value; and
determining that the network has an anomaly when the measured real-time self-similarity value is lower than the set critical value as a result of the comparison.

9. The method according to claim 1,
wherein network traffics of the normal state have self-similarity in which a plurality of network traffics having different scales with respect to time vary have similarity.

10. The method according to claim 1,
wherein the predetermined standard is a supervisory control and data acquisition (SCADA) system having a constant and repeated network pattern with self-similarity.

11. A computer-readable recording medium, on which a program for executing the method defined in claim 1 in a computer is recorded.

12. An apparatus for detecting an anomaly of a network in a predetermined standard having a constant and repeated network pattern with self-similarity, the apparatus comprising:
a storage unit for storing a critical value set by measuring self-similarity from at least one attribute information representing a traffic state of the network in a normal state in advance;
a measuring unit for measuring self-similarity in real time from the at least one attribute information in the network; and
a determining unit for determining an anomaly of the network by comparing the measured real-time self-similarity value with the set critical value.

13. The apparatus according to claim 12,
wherein at least one attribute information representing a traffic state of the network is measured at regular time intervals in the normal state,
a sample mean and dispersion is calculated from the measured attribute information,
a parameter for durability of a statistical phenomenon of the network traffic is calculated by using the calculated dispersion and the time interval, and
a predetermined magnification of the calculated parameter is set as a critical value for the self-similarity and stored in the storage unit.
